(19) United States
(12) Patent Application Publication
(10) Pub. No.: US 2007/0188071 A1
(43) Pub. Date: Aug. 16, 2007

(54) ELECTRON GUN, CATHODE RAY TUBE, AND PROJECTOR

(76) Inventors: Wen Ning Chang, Taoyuan County (TW); Chi-Tsan Wang, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/307,623

(22) Filed: Feb. 15, 2006

(51) Int. Cl. H01J 29/50; H01J 29/46

(52) U.S. Cl. 313/414; 313/441; 313/409

(57) ABSTRACT

An electron gun including a cathode, a beam forming region, an electron lens region, and a high voltage wire is provided. The beam forming region is disposed behind the cathode to make the electrons produced by the cathode become an electron beam. The beam forming region has a control electrode G1 and a screen electrode G2 sequentially. In addition, the electron lens region is adjacent to the beam forming region. The electron lens region has a focusing electrode G3, a focusing electrode G4, and a focusing electrode G5, wherein the focusing electrode G3 and the focusing electrode G4 overlap. Moreover, the high voltage wire is disposed in the electron lens region to connect the focusing electrode G3 and the focusing electrode G5. A cathode ray tube and a projector applying the electron gun are also provided.

### BACKGROUND OF THE INVENTION

1. Field of Invention

The present invention relates to a display device. More particularly, the present invention relates to the structure design of the cathode ray tube of the CRT projector and the electron gun thereof.

2. Description of Related Art

Along with development of the multi-media, the display, served as the interface in communication between people and information becomes much more dominant day after day. In addition to the front-type projection display on which the cathode ray tube (CRT) technique is applied, such as home-use television, monitor and computer screen, another rear-type projection display in which the built-in optical engine and certain optical designs are employed also turns mature gradually for rendering larger display images.

In general, due to having the traits of high brightness and minor volumes, the CRT projectors using rear projection technique are widely used in the occasions where the displaying in larger scale is required, such as home theater projector, lecturing in school or presentation in a meeting/conference for example. In the present marketplace, the PCRT generally combines the CRTs of three colors (R, G and B) provided for the projection on the display screen in front of the observers and the image-displaying in full-color.

The major principle of displaying for the conventional CRT is to produce a electron beam by an electron gun and project it upon the display screen. Wherein, a deflection yoke composed of coils is positioned between the electron gun and display screen for deflecting the electron beam in two-dimensional direction and projecting it on specific positions of the display screen. Besides, the display screen is coated with fluorescent materials in different colors (R, G, B and so on) used for reacting with the electron beam and outputting different color lights.

Referring to FIG. 1, it schematically shows a conventional electron gun in the CRT. As seen in FIG. 1, the conventional electron gun 110 primarily comprises certain parts, including a cathode 112, a beam forming region 114, an electron lens region 116, and so on. The electrons with energy produced by the cathode 112 are emitted into the beam forming region 114 and they sequentially pass through the control electrode G1 and screen electrode G2 for forming an electron beam. After that, the electron beam goes through the focusing electrodes G3, G4 and G5 inside electron lens region 116 and gets focused on the display screen.

Referring to FIG. 1 again, a voltage source is needed to be connected with conventional focusing electrodes G3 and G5 so as to generate an electric field required for focusing. And therefore, a high voltage wire positioned by focusing electrodes G3 and G5 is offered for the connection of focusing electrodes G3 and G5. It's worthy to note that, since there is a gap S between focusing electrodes G3 and G4 in the traditional design, the electric field generated by the high voltage wire 118 may penetrate through this gap s and therefore interferes with the electron beam inside the electron gun 110 and causes deformation of the electron beam. Accordingly, the images to be displayed tend to slur during the projection on the display screen of observers, and focusing performance of the CRT gets worsened and influences displaying quality.

### SUMMARY OF THE INVENTION

In view of this, the object of the present invention is to provide an electron gun, capable of effectively avoiding the interference of outer electric field with the electron beam inside the focusing electrodes G3 and G4, and of preventing the electron beam from deflecting.

Another object of the present invention is to provide a cathode ray tube, capable of effectively avoiding the interference of outer electric field with the electron beam inside the focusing electrodes G3 and G4, and of providing better projection quality and focusing performance.

One another object of the present invention is to provide a projector including an electron gun which is capable of avoiding the interference of outer electric field with the electron beam inside the focusing electrodes G3 and G4 and having better displaying quality.

Based on the above objects or others, the present invention provides an electron gun mainly comprising a cathode, an electron forming region, an electron lens region, and a high voltage wire. The cathode is suitable for producing a plurality of electrons. The beam forming region is disposed behind the cathode and it sequentially includes a control electrode G1 and a screen electrode G2. Besides, the electron lens region is adjacent to the beam forming region and it sequentially includes a focusing electrode G3, a focusing electrode G4 and a focusing electrode G5, and wherein the focusing electrode G3 and focusing electrode G4 partly overlap. The high voltage wire is disposed in the electron lens region for connecting the focusing electrode G3 and the focusing electrode G5.

In the electron gun of the present invention, the diameter of one end of the focusing electrode G4 adjacent to the focusing electrode G3 is shrunk to fit in the focusing electrode G3.

In the electron gun of the present invention, the screen electrode G2 and the focusing electrode G3 are partly overlapped. In one embodiment, the diameter of one end of the focusing electrode G3 adjacent to the screen electrode G2 is shrunk to fit in the screen electrode G2.

The present invention further provides a cathode ray tube mainly comprising an electron gun of the present invention mentioned above, a display screen, and a deflection yoke. Wherein, the high voltage wire is disposed in the electron lens region for connecting the focusing electrode G3 and the focusing electrode G5. Besides, the display screen is disposed behind the electron lens region and the surface of the display screen thereon is coated with a fluorescent material. The deflection yoke is disposed between the electron lens region and the display screen for deflecting the electron beam, such that the electron beam is projected on the display screen and reacts with the fluorescent material to output a color light.

In the cathode ray tube of the present invention, the fluorescent material is red green fluorescent material, green fluorescent material or blue fluorescent material, for example.

Based on the cathode ray tube described above, the present invention further provides a projector which featuring that a plurality of above-mentioned cathode ray tubes capable of emitting different color lights are contained so as to provide the full-color displaying effect.

In the projector of the present invention, said cathode ray tubes may include a red light cathode ray tube, a green light cathode ray tube or a blue light cathode ray tube, for example.

In the structure of the electron gun provided by the present invention, the focusing electrode G3 and focusing electrode G4 partly overlap. By doing so, the electric field outside the electron gun can be effectively shielded by the partly overlapped portion of focusing electrodes G3 and G4, and displaying quality of the projector can be effectively improved.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 schematically shows a conventional electron gun in the CRT.

FIG. 2 schematically shows an electron gun according to one preferred embodiment of the present invention.

FIG. 3 schematically shows a cross-sectional view of a cathode ray tube on which the electron gun of the above embodiment is applied according to the present invention.

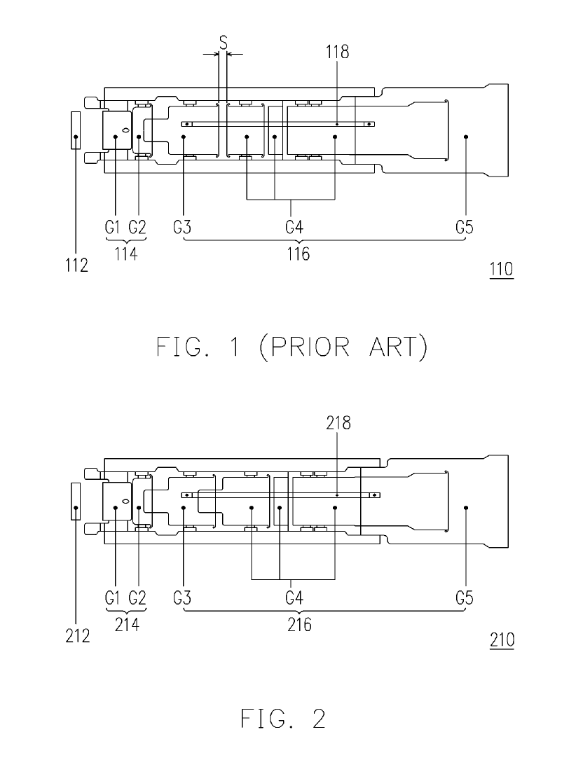

### DESCRIPTION OF THE PREFERRED EMBODIMENTS

FIG. 2 schematically shows an electron gun according to one preferred embodiment of the present invention. As seen in FIG. 2, the electron gun 210 of the present invention mainly comprises a cathode 212, a beam forming region 214, an electron lens region 216, and a high voltage wire 218. The cathode 212 can produce a plurality of electrons with energy. The beam forming region 214 is disposed behind the cathode 212 and it sequentially includes the control electrode G1 and screen electrode G2. When passing through the control electrode G1 and the screen electrode G2, the electrons produced by the cathode 212 are focused as an electron beam. Besides, the electron lens region 216 is adjacent to the beam forming region 214 and it sequentially includes a focusing electrode G3, a focusing electrode G4 and a focusing electrode G5 where the focusing electrode G3 and focusing electrode G4 partly overlap.

Also referring to FIG. 2, one end of the focusing electrode G4 adjacent to focusing electrode G3 may be of stepping shape with a shrunk diameter, and the focusing electrode G4 is fitted in focusing electrode G3 via this shrunk portion. In addition, the high voltage wire 218 is disposed in the electron lens region 216 for connecting the focusing electrode G3 and focusing electrode G5. This high voltage wire 218 is provided to connect the focusing electrode G3 and focusing electrode G5 to an external power supply for forming a focusing electric field. The electron beam formed in the beam forming region 214 is focused and converged after being sequentially processed by the focusing electrodes G3, G4 and G5. Furthermore, the screen electrode G2 and focusing electrode G3 may partly overlap in the present embodiment, for shrinking the diameter of one end of the focusing electrode G3 adjacent to screen electrode G2 such that the focusing electrode G3 is fitted in screen electrode G2.

It's worthy to note that, in addition to the method described above that is to shrink the diameter of one end of the focusing electrode G4 adjacent to focusing electrode G3 for fitting the focusing electrode G4 in focusing electrode G3, there are still other ways to achieve the partly overlapping of the focusing electrode G3 and focusing electrode G4. For example, for the present invention, one end of the focusing electrode G3 adjacent to focusing electrode G4 can be broadened such that the focusing electrode G4 is fitted in focusing electrode G3. Furthermore, according to the present invention, the focusing electrode G3 can be fitted in focusing electrode G4 by using similar ways to achieve the shielding effect of the electric field in the outside.

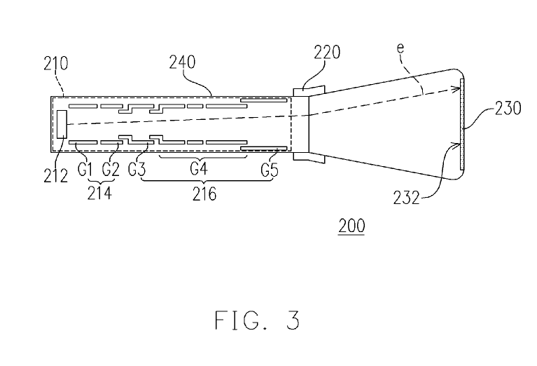

FIG. 3 schematically shows a cross-sectional view of a cathode ray tube on which the electron gun of the above embodiment is applied according to the present invention. For clarity of the diagram, part of the components in FIG. 3 is simplified, and the high voltage wire 218 is not shown. Referring to FIGS. 2 and 3 simultaneously, the cathode ray tube 200 of the present embodiment mainly comprises the electron gun 210 mentioned above, a deflection yoke 220, a display screen 230, and so on. Wherein, the electron gun 210 and deflection yoke 220, for example, are covered by a tube body 240 which is connected to the display screen 230. In the present embodiment, the tube body 240 is a glass tube, for example.

Referring to FIGS. 2 and 3 again, the display screen 230 is disposed behind the electron lens region 216 and it is coated thereon with a fluorescent material 232. The fluorescent material 232 may be red, green or blue fluorescent materials, for example. Additionally, the deflection yoke 220, for example, is composed of coils, and it's disposed between the electron gun 210 and display screen 230 capable of providing an electric field to deflect the electron beam produced by the electron gun 210 in two-dimensional (X-Y) directions. The electron beam e produced by the electron gun 210 is projected on the specific locations of the display screen 230 after passing through deflection yoke 220 and reacts with the fluorescent material on the display screen 230 to output color lights.

As described above, the present invention is to partly overlap the focusing electrodes G3 and G4 for preventing the electron beam e inside focusing electrodes G3 and G4 from being interfered by the electric field that the high voltage wire 218 generates. By doing so, the electron beam can be precisely focused when passing through the electron lens region 216 and will not deform due to interference of the electric field in the outside. Undoubtedly, the design of the present invention can not only prevent interference of the electric field generated by the high voltage wire 218 but also prevent interference of the electric field caused by other factors in the outside. Furthermore, the diameter of focusing electrode G4 is shrunk, so the focusing operation of focusing electrode G4 on the electron beam can be enhanced such that the dB value is minimized. Besides, with the better focusing effect on the electron beam, a better spot size in the corner of images displayed can be maintained after the operation of the deflection yoke 220.

The above-mentioned cathode ray tube, provided by the present invention, can be applied on the rear-type projector, and this projector can have multiple CRTs used for emitting different color lights, such as red, green, and blue CRTs, and so on. The color lights emitted by these CRTs of different color are projected respectively on the display screen in front of the observers and combine together to render the full-color images. Since the electron gun provided by the present invention is able to avoid the interference of the electric field in the outside, the present projector can have a better spot size in the corner of images displayed and the slur phenomenon is improved, thereby providing images with better displaying quality.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. An electron gun, comprising:
a cathode suitable for producing a plurality of electrons;
a beam forming region disposed behind the cathode to make the electrons produced by the cathode become at least an electron beam, wherein the beam forming region sequentially includes a control electrode G I and a screen electrode G2;
an electron lens region adjacent to the beam forming region for focusing the electrons of the electron beam, wherein the electron lens region sequentially includes a focusing electrode G3, a focusing electrode G4 and a focusing electrode G5, and the focusing electrode G3 and the focusing electrode G4 partly overlap; and
a high voltage wire disposed in the electron lens region for connecting the focusing electrode G3 and the focusing electrode G5.

2. The electron gun according to claim 1, wherein the diameter of one end of the focusing electrode G4 adjacent to the focusing electrode G3 is shrunk to fit in the focusing electrode G3.

3. The electron gun according to claim 2, wherein the screen electrode G2 and the focusing electrode G3 are partly overlapped.

4. The electron gun according to claim 3, wherein the diameter of one end of the focusing electrode G3 adjacent to the screen electrode G2 is shrunk to fit in the screen electrode G2.

5. A cathode ray tube, comprising:
an electron gun comprising:
a cathode, suitable for producing a plurality of electrons;
a beam forming region disposed behind the cathode to make the electrons produced by the cathode become at least an electron beam, wherein the beam forming region sequentially includes a control electrode G1 and a screen electrode G2;
an electron lens region adjacent to the beam forming region for focusing the electrons of the electron beam, wherein the electron lens region sequentially includes a focusing electrode G3, a focusing electrode G4 and a focusing electrode G5, and the focusing electrode G3 and the focusing electrode G4 partly overlap; and
a high voltage wire disposed in the electron lens region for connecting the focusing electrode G3 and the focusing electrode G5;
a display screen disposed behind the electron lens region, wherein the surface of the display screen thereon is coated with a fluorescent material; and
a deflection yoke disposed between the electron lens region and the display screen for deflecting the electron beam, such that the electron beam is projected on the display screen and reacts with the fluorescent material to output a color light.

6. The cathode ray tube according to claim 5, wherein the diameter of one end of the focusing electrode G4 adjacent to the focusing electrode G3 is shrunk to fit in the focusing electrode G3.

7. The cathode ray tube according to claim 6, wherein the screen electrode G2 and the focusing electrode G3 are partly overlapped.

8. The cathode ray tube according to claim 7, wherein the diameter of one end of the focusing electrode G3 adjacent to the screen electrode G2 is shrunk to fit in the screen electrode G2.

9. The cathode ray tube according to claim 5, wherein the fluorescent material includes red fluorescent material.

10. The cathode ray tube according to claim 5, wherein the fluorescent material includes green fluorescent material.

11. The cathode ray tube according to claim 5, wherein the fluorescent material includes blue fluorescent material.

12. A projector, having a plurality of cathode ray tubes, wherein each cathode ray tube comprises:
an electron gun comprising:
a cathode, suitable for producing a plurality of electrons;
a beam forming region disposed behind the cathode to make the electrons produced by the cathode become at least an electron beam, wherein the beam forming region sequentially includes a control electrode G1 and a screen electrode G2;
an electron lens region adjacent to the beam forming region for focusing the electrons of the electron beam, wherein the electron lens region sequentially includes a focusing electrode G3, a focusing electrode G4 and a focusing electrode G5, and the focusing electrode G3 and the focusing electrode G4 partly overlap; and
a high voltage wire disposed in the electron lens region for connecting the focusing electrode G3 and the focusing electrode G5;
a display screen disposed behind the electron lens region, wherein the surface of the display screen thereon is coated with a fluorescent material; and
a deflection yoke disposed between the electron lens region and the display screen for deflecting the electron beam, such that the electron beam is projected on the display screen and reacts with the fluorescent material to output a color light.

13. The projector according to claim 12, wherein the diameter of one end of the focusing electrode G4 adjacent to the focusing electrode G3 is shrunk to fit in the focusing electrode G3.

14. The projector according to claim 13, wherein the screen electrode G2 and the focusing electrode G3 are partly overlapped.

15. The projector according to claim 14, wherein the diameter of one end of the focusing electrode G3 adjacent to the screen electrode G2 is shrunk to fit in the screen electrode G2.

16. The projector according to claim 12, wherein the cathode ray tubes include one of a red light cathode ray tube, a green light cathode ray tube and a blue light cathode ray tube.
